(19) United States
(12) Patent Application Publication
(10) Pub. No.: US 2002/0020039 A1
(43) Pub. Date: Feb. 21, 2002

(54) Handle arrangement

(76) Inventor: Nigel Victor Spurr, West Midlands (GB)

Correspondence Address: Anthony P. Cho, CARLSON, GASKEY & OLDS, P.C., Suite 350, 400 West Maple Road, Birmingham, MI, 48009, US

(21) Appl. No.: 09/925,599

(22) Filed: Aug. 10, 2001

(30) Foreign Application Priority Data
Aug. 19, 2000 (GB) GB0020402.4

(51) Int. Cl. E05B 1/00

(52) U.S. Cl. 16/412

(57) ABSTRACT

A handle arrangement, including a handle and an element, the handle having a first, second and third position, the handle being biased towards the second position when in the first position, the element being arranged such that when the handle is released from the first position, the element acts to prevent the handle from achieving the third position, the element being arranged such that when the handle is positioned stationary in the second position the element does not act to prevent movement of the handle from the second position to the third position.

This application claims priority to United Kingdom Application GB No. 0020402.4 filed Aug. 19, 2000.

### BACKGROUND OF THE INVENTION

The present invention relates to handle arrangements, in particular handle arrangements for closures in vehicles where locking is achieved by pushing the inside handle from a rest position to a locked position.

In known vehicles, an inside door handle can have a first released position, a second rest position, wherein the associated door is unlocked, and a third locked position. The second and third positions are stable positions, in that when the handle is put in these positions it remains there. However, the first position is unstable, in that the handle will not stay in this position when released.

Pulling the inside handle from the locked position to the rest position unlocks the door. Further movement of the inside handle to the released position then unlatches the door. If the handle is pulled to unlatch the door and released, there is the possibility that due to the spring forces in the handle system, the handle will not simply revert to the rest position, but will continue to move to the locked position. This phenomena is referred to as ‘snap back’ locking, and potentially causes customer dissatisfaction.

There are potential solutions to overcome this phenomena, such as reducing the spring forces in the handle system. However, this is not always possible since the spring forces must be of sufficiently high value to both resist the inertia of system components during crash deceleration, and return all moving elements to their rest positions to ensure full engagement of latch pawl and claw.

It would also be possible to increase the locking mechanism spring force to counter the spring force in the system, but this would result in increased key operating effort.

An object of the present invention is to provide a handle arrangement which overcomes the ‘snap back’ phenomena.

### SUMMARY OF THE INVENTION

According to the present invention there is provided a handle arrangement, including a handle and an element, the handle having a first, second and third position, the handle being biased towards the second position when in the first position, the element being arranged such that when the handle is released from the first position, the element acts to prevent the handle from achieving the third position, the element being arranged such that when the handle is positioned stationary in the second position the element does not act to prevent movement of the handle from the second position to the third position.

Advantageously this allows for relatively high spring forces in the handle system to resist crash inertia forces, and also relatively low spring forces in the lock mechanics to provide for low key operating effort.

Preferably the element is affected by inertia forces such as centripetal forces, such that when the handle is released from the first position, the element acts to prevent the handle from achieving the third position

Advantageously such an arrangement utilizes the kinetic movement of the handle between the first and second positions to prevent continued movement to the third position.

Preferably the handle arrangement includes a member such that when the handle is released from the first position, the member cooperates with the element to prevent the handle from achieving the third position.

Preferably, the member may be a fixed stop face, the cooperation between the external member and the element being physical contact. However, in other embodiments the member may include a magnetic field generating portion, the cooperation between the member and the element in this case being non-physical.

### BRIEF DESCRIPTION OF THE DRAWINGS

The invention will now be described, by way of example only, with reference to the accompanying drawings in which:

FIG. 1 is a plan view of the handle arrangement according to the present invention;

FIG. 2 shows the handle of FIG. 1 in its first position corresponding to the release position of an associated latch;

FIG. 3 shows the handle of FIG. 1 in its second position immediately after being released from its first position;

FIG. 4 shows the handle of FIG. 1 in its second position corresponding to the rest position of an associated latch; and

FIG. 5 shows the handle of FIG. 1 in its third position corresponding to the locked position of an associated latch.

### DESCRIPTION OF THE PREFERRED EMBODIMENTS

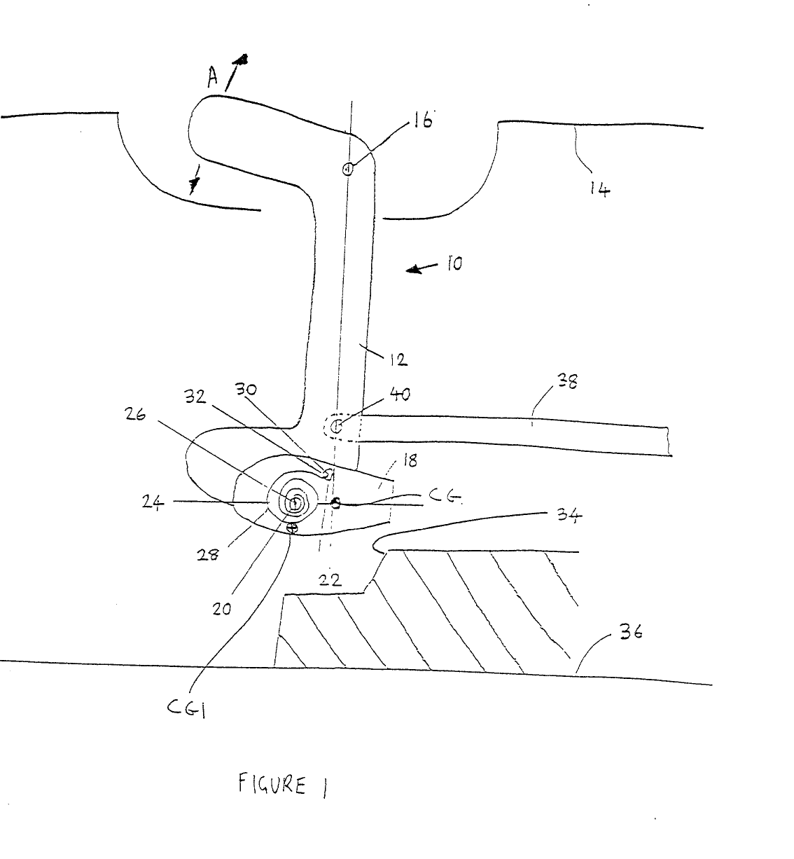

A handle arrangement 10, shown in FIG. 1, includes a handle 12, pivotally attached to an inner door skin 14 using a pin 16. A pawl 18 is pivotally attached to the handle 12 using a split shaft 20. The pawl 18 is arranged such that its pivot point about the split shaft 20 does not coincide with its center of gravity CG. In this way, any force acting on the pawl 18, as the handle 12 (and hence the pawl 18) rotate about the pin 16, will generate a moment allowing the pawl 18 to rotate about the split shaft 20.

The split shaft 20 is located such that a first line 22 between the center of gravity CG of the pawl 18 and the pin 16, and a second line 24 between the center of gravity CG of the pawl 18 and the split shaft 20 are perpendicular to each other. This has the effect of maximizing a moment generated by a centripetal force acting on the pawl 18.

In further embodiments the first line 22 and second line 24 need not be perpendicular to provide for generation of a centripetal moment about the split shaft 20.

A first end 26 of a circular spring 28, is attached to the split shaft 20, and a second end 30 of the circular spring 28 is attached to a fixing point 32 of the pawl 18. The circular spring 28 is arranged such that a force is generated between the pawl 18 and the handle 12, the force acting to bias the pawl 18, such that the pawl 18 reverts to a first pawl position as shown in FIG. 1.

The pawl 18 is arranged relative to the handle 12 such that it may cooperate with a fixed stop face 34, the fixed stop face being secured to an outer door skin 36.

The handle 12, is attached to a rod 38 using a pin 40, the rod 38 is connected to an associated latch, and the handle is able to occupy three positions, a first position, in which the handle 12 is pulled away from the inner door skin 14, which corresponds to the associated latch being released, a second position, in which the associated latch is neither released nor locked, and a third position, in which the associated latch is locked.

The operation of the device is as follows:

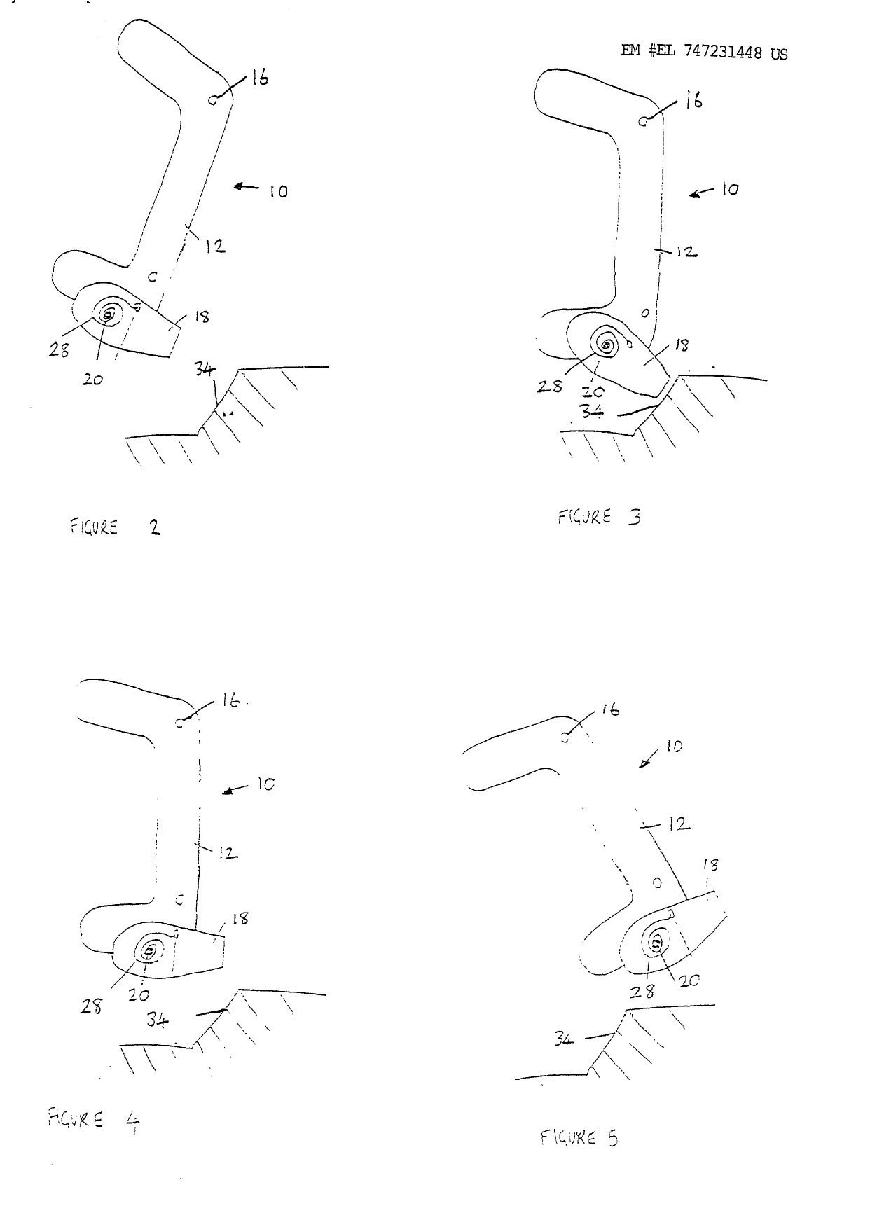

To open the vehicle door from inside the vehicle, it is necessary to release the associated door latch. The door latch is released from inside the vehicle by pulling the handle 12 away from the door in the direction of arrow A, to move the rod 38 to unlatch the latch. With the handle 12 occupying the first position, as shown in FIG. 2, the pawl 18 is in a corresponding first pawl position. When the handle 12 is released, the handle 12 rotates about the pin 16, and a centrifugal force is generated on the pawl 18 which is sufficient to overcome the spring force in the circular spring 28. The centrifugal force acts about the center of gravity of the pawl 18 which is offset from the split shaft 20, causing the pawl 18 to rotate from its first position, as shown in FIG. 2, to its second position, as shown in FIG. 3.

As the handle 12 moves towards the second handle position (see FIG. 3), the position of the pawl 18 causes the pawl 18 to hit the fixed stop face 34, and therefore prevent the handle 12 from continuing to its third position (as shown in FIG. 5).

After the pawl 18 hits the fixed stop face 34, the handle 12 is no longer rotating, and the pawl 18 is no longer acted on by a centrifugal force. The pawl will then revert to its first position due to the action of the spring force and will no longer cooperate with the fixed stop face 34 (see FIG. 4). The handle 12 can now be manually moved to its third position shown in FIG. 5.

In an alternative embodiment, if the center of gravity of the pawl 18 is positioned at CG1, i.e. in a line joining the pin 16 with the split shaft 20 then, while centripetal forces will tend to maintain CG1 on a line joining the pin 16 with the split shaft 20, inertia forces caused by the rotational acceleration of handle 12 about pin 16 will cause the pawl 18 to rotate clockwise about the split shaft 20, relative to the handle 12, as the handle 12 rotationally accelerates anticlockwise about pin 16 such that the pawl achieves the position shown in FIG. 3.

In a further embodiment, the external force may be generated by linear movement of the handle arrangement as opposed to rotational movement, such that an inertial force acts on the element.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

We claim:

1. A handle arrangement, including a handle and an element, the handle having a first, second and third position, the handle being biased towards the second position when in the first position, the element being arranged such that when the handle is released from the first position, the element acts to prevent the handle from achieving the third position, the element being arranged such that when the handle is positioned stationary in the second position the element does not act to prevent movement of the handle from the second position to the third position.

2. A handle arrangement according to claim 1 in which the element is affected by inertial forces, such that when the handle is released from the first position, the element acts to prevent the handle from achieving the third position.

3. A handle arrangement according to claim 1 in which the element is affected by centripetal forces, such that when the handle is released from the first position, the element acts to prevent the handle from achieving the third position.

4. A handle arrangement according to claim 1 in which the element is biased by a resilient means towards a position, such that when the handle is positioned stationary in the second position, the element does not act to prevent movement of the handle from the second position to the third position.

5. A handle arrangement according to claim 1 in which the element is rotatably mounted.

6. A handle arrangement according to claim 1 in which the element is mounted on the handle.

7. A handle arrangement according to claim 1 in which the element is a pawl.

8. A handle arrangement according to claim 1 in which the first position corresponds to a release position of an associated latch.

9. A handle arrangement according to claim 1 in which the second position corresponds to a rest position of an associated latch.

10. A handle arrangement according to claim 1 in which the third position corresponds to a locked position of an associated latch.

11. A handle arrangement according to claim 1 further including a member, such that when the handle is released from the first position, the member cooperates with the element to prevent the handle from achieving the third position.

12. A handle arrangement according to claim 11 in which the member is a fixed stop face.

13. A handle arrangement according to claim 11, in which the element cooperates with the member due to the action of an inertial force.

14. A handle arrangement according to claim 11 in which the element cooperates with the member due to the action of an centripetal force.
